(19) United States
(12) Patent Application Publication
(10) Pub. No.: US 2025/0379019 A1
(43) Pub. Date: Dec. 11, 2025

(54) FIELD-EFFECT EMITTER MICROSTRUCTURE WITH INCREASED PROTECTION

(71) Applicant: Siemens Healthineers AG, Forchheim (DE)

(72) Inventors: Christoph JUD, Nuernberg (DE); Peter GEITHNER, Erlangen (DE); Anja FRITZLER, Erlangen (DE)

(73) Assignee: Siemens Healthineers AG, Forchheim (DE)

(21) Appl. No.: 19/228,959

(22) Filed: Jun. 5, 2025

(30) Foreign Application Priority Data
Jun. 7, 2024 (EP) 24180798.1

(51) Int. Cl. H01J 35/06

(52) U.S. Cl. CPC H01J 35/065

(57) ABSTRACT

A field-effect emitter microstructure for an X-ray tube has an emitter needle, a gate electrode with a gate opening, a first insulating layer, wherein free electrons can be produced in the field-effect emission segment via an emission voltage which can be applied between the gate electrode and the field-effect emission segment. A lower side of a second insulating layer at least partially abuts an upper side of the gate electrode, an upper side of the second insulating layer at least partially abuts a lower side of a focusing layer, and the second insulating layer and the focusing layer each have a through-opening for the free electrons.

### CROSS-REFERENCE TO RELATED APPLICATION(S)

The present application claims priority under 35 U.S.C. § 119 to European Patent Application No. 24180798.1, filed Jun. 7, 2024, the entire contents of which are incorporated herein by reference.

### FIELD

One or more example embodiments relates to a field-effect emitter microstructure, an electron emitter apparatus, an X-ray tube and a method for generating X-rays via an X-ray tube.

### RELATED ART

Field-effect emitter microstructures as electron sources in a vacuum are basically known. Field effect emitter microstructures are advantageous, in particular when used as electron emitters in evacuated X-ray tubes, owing to their fast switching capacity, the possibility of pixelization of the emission area and/or depending on design, the comparatively high electron emission current density. Guerrera et al., for example, disclose silicon field-effect emitter microstructures with an electron emission density above 100 A/cm\hat{ }2 in “Silicon Field Emitter Arrays With Current Densities Exceeding 100 A/cm\hat{ }2 at Gate Voltages Below 75 V” (IEEE ELECTRON DEVICE LETTERS, VOL. 37, NO. 1, January 2016).

A typical problem during operation of field-effect emitter microstructures is, in particular, the current which discharges via the gate electrode, formed by some of the electrons flowing through the emitter needles. The cause of this gate current is, for example, an electrically conductive contact between a gate electrode of the field-effect emitter microstructure and an emitter needle of the field-effect emitter microstructure owing to a faulty production process and/or mechanical damage. Alternatively or in addition, contaminants can connect emitter needles to the gate electrode. Damage in the form of a conductive connection to the gate electrode can develop owing to excessive currents through individual emitter needles. Such conductive connections can alternatively or additionally develop due to high-voltage flashovers on the field-effect emitter microstructure. A further example relates to it being possible for a gate current to develop without direct, conductive connection between gate electrode and emitter needle, namely due to a scattering of the emitted electrons, with some of the scattered electrons discharging via the gate electrode.

A high-voltage flashover typically optionally has the following consequences:
the gate electrode can vaporize so it is not possible for an emission voltage to build up for the emitter needles underneath. In this case, an undamaged part of the field-effect emitter microstructure can advantageously continue to produce free electrons.
the gate electrode can melt and close the gate openings so electrons generated at the emitter needles underneath can strike the fused gate electrode which can ultimately vaporize as a result.
the gate electrode can melt and produce an electrically conductive connection to an emitter needle so it is not possible for an emission voltage to build up between gate electrode and typically all emitter needles owing to the electrical short circuit, for which reason the entire field-effect emitter microstructure can typically no longer generate electrons.

In “Failure Mode of Si Field Emission Arrays based on Emission Pattern Analysis,” 2021 34th International Vacuum Nanoelectronics Conference (IVNC), Lyon, France, 2021, pp. 1-2, doi: 10.1109/IVNC52431.2021.9600740, R. F. Asadi, T. Zheng, J. Da Silva, G. Rughoobur, A. I. Akinwande and B. Gnade, describe that basically individual faults, in particular the previously described damage, frequently have adverse effects on the entire field-effect emitter microstructure since the emission voltage is customarily impaired.

### SUMMARY

One or more example embodiments is based on the object of disclosing a field-effect emitter microstructure, an electron emitter apparatus, an X-ray tube and a method for generating X-rays via an X-ray tube with increased protection.

The is achieved by the features of the independent claims. Advantageous embodiments are described in the subclaims.

### BRIEF DESCRIPTION OF THE DRAWINGS

The invention will be described and explained in more detail below using the exemplary embodiments represented in the figures. Basically, substantially unchanging structures and units are designated in the following description of the figures with the same reference numerals as in the case of the first occurrence of the respective structure or unit.

In the drawings:

FIG. 1 shows an inventive field-effect emitter microstructure,

FIG. 2 shows a first exemplary embodiment of the field-effect emitter microstructure,

FIG. 3 shows a first operating behavior of the first exemplary embodiment,

FIG. 4 shows a second and a third operating behavior of the first exemplary embodiment,

FIG. 5 shows a second exemplary embodiment of the field-effect emitter microstructure,

FIG. 6 shows a third exemplary embodiment,

FIG. 7 shows an inventive electron emitter apparatus,

FIG. 8 shows an inventive X-ray tube and

FIG. 9 shows an inventive method for generating X-rays via an X-ray tube.

### DETAILED DESCRIPTION

The inventive field-effect emitter microstructure for an X-ray tube has
an emitter needle, wherein the emitter needle has a field-effect emission segment at a first end,
a gate electrode with a gate opening, wherein the gate opening connects a lower side of the gate electrode which faces the emitter needle to an upper side of the gate electrode which is remote from the lower side, wherein the longitudinal center axis of the emitter needle perpendicular to the gate electrode is aligned with the gate opening in the emission direction, and
a first insulating layer, which at least partially abuts the emitter needle, at least below the field-effect emission segment, and the lower side of the gate electrode,
wherein free electrons can be produced in the field-effect emission segment via an emission voltage which can be applied between the gate electrode and the field-effect emission segment, and is characterized by
a second insulating layer with a lower side which faces the emitter needle and an upper side which is remote from the lower side,
an electrically conductive focusing layer with a lower side which faces the emitter needle and an upper side which is remote from the lower side,
wherein the lower side of the second insulating layer at least partially abuts the upper side of the gate electrode,
wherein the upper side of the second insulating layer at least partially abuts the lower side of the focusing layer,
wherein the second insulating layer as well as the focusing layer each have a through-opening for the free electrons which can be produced in the field-effect emission segment.

The inventive electron emitter apparatus has
a field-effect emitter microstructure and
a voltage source interconnected with the field-effect emitter microstructure to provide an emission voltage and/or a focus voltage.

The inventive X-ray tube has
a housing with an evacuable interior,
an electron emitter apparatus in the interior and
an anode in the interior for generating X-rays as a function of free electrons which can be generated via the electron emitter apparatus.

The inventive method for generating X-rays via an X-ray tube comprises the following steps:
applying an emission voltage between the gate electrode and the emitter needle for producing free electrons,
applying a focus voltage between the focusing layer and the gate electrode for focusing the free electrons,
generating X-rays via the anode of the X-ray tube by way of an interaction with the focused free electrons.

One advantage of example embodiments is that the free electrons can be focused via the focusing layer. In this case, the conventional deflecting unit for an electrostatic or electromagnetic focusing of the electrons can preferably be omitted. The focusing layer is particularly advantageous owing to its spatial proximity to the field-effect emission segment compared to a conventional deflecting unit and is therefore particularly suitable for the focusing. Close to the field-effect emission segment the electrons can be focused in the focusing direction via a, compared to a conventional focus voltage, low electrical field component, in particular since they still have a low speed. Preferably, adequate focusing can be achieved with moderate focus voltages, meanwhile the main component of the field induces an acceleration of the electrons.

A further advantage is that a portion of the free electrons conventionally flying onto the gate electrode is deflected by the focusing and the gate current is consequently reduced. This is advantageous precisely for designs in which the current of the free electrons is maximized up to 100 A/cm\hat{ }2. This advantage applies, in particular, in the case of field-effect emitter microstructures with emitter needles made of silicon compared to field-effect emitter microstructures with emitter needles made of carbon, with the latter typically having an external grid electrode at a greater distance from the emitter needles.

A further advantage of invention relates to the focusing layer instead of the gate electrode being exposed to the anode compared to a conventional field-effect emitter microstructure. The advantageous consequence of this is that primarily the focusing layer is damaged in the event of a voltage flashover from the anode to the field-effect emitter microstructure. At the very least the probability of the voltage flashover striking the focusing layer and not the gate electrode or the emitter needle is significantly increased. Ideally, such a voltage flashover therefore has no effect at all or causes only a comparatively strong flashover to the gate electrode. If the focusing layer is damaged, typically only the focusing of the electrons is impaired or prevented. In contrast to damage to the gate electrode of a conventional field-effect emitter microstructure, which can result in failure of the entire field-effect emitter microstructure. For example, a melted focusing layer still has to span the insulating distance along the second insulating layer before the flashover can exert an indirect, adverse effect on the gate electrode and/or the emitter needle.

Example embodiments are also advantageous in that the focusing layer can be designed to be virtually as thick as desired, in such a way as to have a high thermal capacity, as may be necessary in the event of voltage flashovers. Advantageously, the currents that occur in the event of a flashover can be diverted without damage to the field-effect emitter microstructure.

The field-effect emitter microstructure is suitable for an X-ray tube in such a way that in terms of amount, electrons generated via the field-effect emitter microstructure form those tube currents in a vacuum, which are adequate for imaging and/or a therapeutic application via the X-ray radiation produced at the anode. Depending on application, a current density of up to approx. 10 A/cm\hat{ }2 is necessary in the focal spot on the anode. Conventional, thermionic emitters have current densities of approx. 3 A/cm\hat{ }2, for which reason the conventional, thermionic emitters cannot be mapped directly onto the focal spot. Inventive field-effect emitter microstructures, by contrast, can have emission areas which reach current densities of, for example, up to 100 A/cm\hat{ }2. A direct mapping would therefore basically be possible, for example via suitable focusing. The imaging can be, in particular, computed tomography, angiography, mammography, conventional radiography, image-based material testing and/or image-based customs control. The therapeutic application of the X-rays can be, in particular, radiotherapy.

The field-effect emitter microstructure substantially relates to an arrangement of microstructure component parts, in particular of the emitter needle, the gate electrode, the first insulating layer, the second insulating layer and the electrically conductive focusing layer, relative to one another. The field-effect emitter microstructure has, in particular, structures in the micrometer range or the nanometer range. The field-effect emitter microstructure is, in particular, a microstructure component. The field-effect emitter microstructure can be a semiconductor component part. The field-effect emitter microstructure can be produced, in particular, by a semiconductor manufacturer.

A field-effect emitter microstructure with just a single emitter needle is frequently smaller in its dimensions by at least one order of magnitude compared to a conventional thermionic electron emitter. A field-effect emitter microstructure with a plurality of emitter needles, in particular with a large number of emitter needles, can have substantially the same dimensions as a conventional thermionic electron emitter.

The field-effect emitter microstructure has, in particular, terminals for tapping the emission voltage and/or the focus voltage. For example, the gate electrode can have terminals for tapping a first potential of the emission voltage. For example, the emitter needle and/or an electrical supply to the emitter needle can have a terminal for tapping a second potential of the emission voltage. Typically, the first focusing layer has a terminal for tapping a first potential of the focus voltage. Depending on the reference point of the focus voltage, the terminal of the emitter needle or the terminal of the gate electrode can tap a second potential of the focus voltage. By definition the focus voltage is applied between the focusing layer and the gate electrode.

The voltage source of the electron emitter apparatus can preferably produce the emission voltage and/or the focus voltage and provide it at the terminals of the field-effect emitter microstructure. The voltage source can have lead wires, in particular supply lines and/or conductor paths for providing the voltage. The voltage which has been produced is applied by the provision of a voltage produced at the terminals.

The housing of the X-ray tube typically has metal and/or glass. The housing of the X-ray tube can typically be temperature-controlled, preferably cooled, during operation of the X-ray tube via a medium which interacts with the outside of the housing, and/or be electrically insulated. The housing of the X-ray tube is, in particular, high voltage-resistant. The interior of the housing can be evacuated. The housing can have an apparatus, for example a housing opening and/or a valve, in order to evacuate the interior. The vacuum in the interior is typically a high vacuum. The electron emitter apparatus as well as the anode are typically arranged opposite one another within the interior.

Typically, a high voltage to accelerate the free electrons is applied between the anode and the electron emitter apparatus, which typically forms the cathode. The high voltage can be, for example, up to 200 kV, typically between 20 and 150 kV. The high voltage is typically produced by a high voltage source and/or provided at the anode or cathode. After the acceleration the electrons interact with the anode to generate the X-rays. The anode can be, in particular, a rotating anode or a stationary anode. Alternatively it is conceivable that the anode is mounted together with the housing to be rotatable. In this case, the anode and the housing are typically non-rotatably connected to one another. The anode can advantageously be connected upstream of a series resistor in order to limit a short-circuit current through the focusing layer.

The emitter needle is, in particular, a field-effect emitter. The emitter needle is typically a nano- or microstructure component. The emitter needle can alternatively be referred to as a nanotube. The term carbon nanotube, for example, is also known for emitter needles made of carbon. The emitter needle is typically electrically conductive and/or a semiconductor. The emitter needle can be made of carbon or silicon or a different material. Preferably, the emitter needle is embodied as a silicon emitter needle in the manner as described by Guerrera et al.

The emitter needle is an elongate and narrow column. The emitter needle can typically be divided into two functional segments. Arranged at the first end is the field-effect emission segment from which electrons can exit the emitter needle via the field effect in order to be able to move them away from the emitter needles as free electrons. Arranged at the second end is, for example, a connecting segment which serves to pass the electrons from a current source through to the field-effect emission segment and does not typically contribute, and/or barely contributes, to electron emission. The connecting portion can be embodied, in particular, to supply an electrical potential of the emission voltage to the field-effect emission segment. The emitter needle can additionally have a current-limiting unit which is arranged, in particular, upstream of the field-effect emission segment, for example between the field-effect emission segment and the connecting segment in order to be able to limit a flow of current through the emitter needle. In particular, the current-limiting unit can be a transistor or a different switch. The current-limiting unit can be arranged at the second end of the emitter needle.

The emitter needle can be, in particular, pin-shaped. The emitter needle can customarily be divided into two geometric portions, in particular a portion with a constant, in particular round or polygonal, cross-section and a tapered portion. The connecting portion is typically part of the cylindrical portion. The field-effect emission segment is typically part of the tapered portion. Typically most electrons exit at the outermost tip or the region of the tapered portion of the emitter needle adjacent to the outermost tip. The angle enclosed by the tapered portion and the longitudinal center axis can be, for example, 30°.

The emission direction of the emitter needle typically lies on the longitudinal center axis of the emitter needle. The emission direction is typically away from the field-effect emission segment in the direction of the focusing layer. The emission direction is displayed, in particular, by the tapered portion of the emitter needle.

The gate electrode is, in particular, a gate electrode layer. The gate electrode is electrically conductive, in particular made of a metal or of a doped material, to which a metallic top layer can be applied.

The gate electrode has, in particular the gate opening, the lower side which faces the emitter needle and the upper side which is remote from the lower side. The gate opening is a cavity which connects, in particular, the lower side of the gate electrode to its upper side and/or is limited by an inner wall of the gate electrode. The gate opening is preferably enveloped by the inner wall of the gate electrode.

The term “diameter” will hereinafter be used on the proviso that the diameter is basically defined in the plane of the respective layer and that the maximum diameter will be considered in the case of units, in particular openings, which are not round. Insofar as units, for example openings, perpendicular to the respective layer, for example in the emission direction and/or along the longitudinal center axis of the emitter needle, have varying diameters, unless specified otherwise, the diameter refers to a mean diameter, formed of the (maximum) location-dependent, varying diameters. The mean diameter is, in particular, an arithmetic mean.

The gate opening is preferably rotationally symmetric. The gate opening preferably comprises a cylindrical volume. The gate opening has, in particular, a circular cross-section. Customarily, a diameter of the gate opening is larger than a diameter transverse to the longitudinal center axis of the emitter needle. The gate opening is embodied, in particular, for passage of the free electrons.

The gate electrode, in particular perpendicular to the emitter needle, is aligned in such a way that the longitudinal center axis of the emitter needle preferably centrally intersects the cross-section of the gate opening. The gate electrode and the emitter needle are arranged approximately in a T-shape. The long leg is formed, in particular, by the emitter needle which divides the gate electrode centrally in the gate opening into approximately two small legs. The gate electrode and the emitter needles are not electrically connected to one another. The emitter needle or the longitudinal center axis of the emitter needle intersects the gate electrode in its gate opening in particular without an electrically conductive connection. Preferably, the center axis of the gate opening and the longitudinal center axis of the emitter needle coincide.

In the present application, “abutting” means that a unit, in particular a layer, which abuts another unit, in particular another layer, has full-surface and touching contact with the other unit. Mutually butting units or layers typically do not have cavities between them, and instead, if at all, have production-related minimal gaps in the nano- or micrometer range.

That a unit, in particular a layer, at least partially abuts another unit, in particular another layer, includes, in particular, that the other unit at least partially abuts the unit, and can mean that the other unit completely abuts the unit. In other words, whether, according to perspective, the one abuts the other only partially and the other abuts the one completely is dependent on the dimensions and/or the respective arrangement of the units or the layers relative to one another. When assessing whether there is partial or complete abutment, the regions around the gate opening or the respective through-opening, in particular, will be considered in the present application. The degree of abutment describes, in particular, a proportion of the coverage and, in particular, not a quality of the connection to one another.

The first insulating layer is suitable, in particular, for an electrical insulation of the emitter needle in relation to the gate electrode, and vice versa. The first insulating layer frequently does not couple the emitter needle and the gate electrode conductively, but rather primarily mechanically.

The first insulating layer is made, for example, from silicon oxide. The first insulating layer is made, in particular, of an electrically non-conductive and/or a dielectric material. The first insulating layer is, in particular, a body through which the emitter needle can be aligned relative to the gate electrode without producing an electrical connection between them in the process. The first insulating layer can be referred to as an insulation matrix.

In relation to the T-shaped arrangement of the gate electrode and the emitter needle, the first insulating layer fills, in particular, the half spaces below the short legs of the gate electrode through to the emitter needle. Conventionally, the cylindrical portion of the emitter needle is typically completely surrounded by the first insulating layer. Basically it is conceivable that the tapered portion of the emitter needle at least partially abuts the first insulating layer.

It can be that the first insulating layer projects beyond the gate electrode, or vice versa. The first insulating layer has the upper side which faces the gate electrode and the lower side which is remote from the upper side. That the first insulating layer at least partially abuts the lower side of the gate electrode means, in particular, that the upper side of the first insulating layer does not abut the lower side of the gate electrode to a certain extent. The lower side of the gate electrode can completely abut the upper side of the first insulating layer. It is conceivable that a closed region adjoining the gate opening on the lower side of the gate electrode is not covered by the first insulating layer and thus does not abut the first insulating layer. In other words, a frame of the gate opening on the lower side can be uninsulated. Alternatively, depending on the embodiment, it is conceivable that the first insulating layer abuts the lower side of the gate electrode through to gate opening.

The emitter needle is embedded in the first insulating layer at least below the field-effect emission segment. Embedded means full-surface mutual abutment.

The emission voltage can, in particular, be between greater than zero and less than or equal to 1,000 V, in particular between 1 V and 100 V, and preferably be 50 V. The electrical potential of the field-effect emission segment is typically more negative during the electron emission than the electrical potential of the gate electrode. It is conceivable that the electrical potential of the gate electrode is 0 V or is negative. Electrons in the field-effect emission segment frequently exit the emitter needle due to the application of the emission voltage.

The second insulating layer has the lower side which faces the emitter needle and the upper side which is remote from the lower side, as well as the through-opening which connects the upper side of the second insulating layer and the lower side of the second insulating layer. The second insulating layer preferably at least partially covers the gate electrode. It is conceivable that a closed region, adjoining the gate opening, on the upper side of the gate electrode is not covered by the second insulating layer and thus does not abut the second insulating layer. In other words, a frame of the gate opening on the upper side can be uninsulated. Alternatively, depending on the embodiment, it is conceivable that the second insulating layer abuts the upper side of the gate electrode in such a way that the through-opening of the second insulating layer as well as the gate opening have the same diameter as well as their center axes coinciding.

The through-opening of the second insulating layer is limited by an inner wall of the second insulating layer. The through-opening of the second insulating layer is preferably enveloped by the inner wall of the second insulating layer. The through-opening of the second insulating layer is embodied, in particular, for passage of the free electrons.

The second insulating layer can be made, in particular, of silicon dioxide. The second insulating layer is made, in particular, of an electrically non-conductive and/or a dielectric material. The first insulating layer and the second insulating layer can be made of the same material. Typically, the first insulating layer is more voluminous than the second insulating layer. The second insulating layer typically has a thickness which is less than a thickness of the first insulating layer. The second insulating layer has, in particular, a dielectric strength of at least 100 V/μm, preferably at least 400 V/μm.

The focusing layer is, in particular, a focusing electrode. The focusing layer has the lower side which faces the emitter needle and the upper side which is remote from lower side, as well as the through-opening which connects the upper side of the focusing layer and the lower side of the focusing layer. Advantageously, the focusing layer covers the upper side of the second insulating layer completely. The through-opening of the focusing layer is limited by an inner wall of the focusing layer. The through-opening of the focusing layer is preferably enveloped by the inner wall of the focusing layer. The through-opening of the focusing layer is embodied, in particular, for passage of the free electrons. A focus voltage can be applied to the focusing layer to focus the free electrons which can be generated in the field-effect emission segment.

In the present application, focusing means, in particular, influencing of the trajectories of the free electrons in such a way that a spatial distribution of the emitted electrons perpendicular to the emission direction is changed, in particular is increased and/or decreased. The change can comprise an increase in the spatial distribution, also called defocusing, and a decrease in the spatial distribution, also called focusing. In other words, the focusing layer is configured for focusing and defocusing of the free electrons.

The focus voltage can be, in particular, between minus 5,000 V and plus 5,000 V, in particular between minus 1,000 V and plus 1,000 V, preferably 200 V or 50 V. The electrical potential of the gate electrode is preferably more negative during the electron emission than the electrical potential of the focusing layer. The inventors have identified that, advantageously, a reduction in the spatial distribution of the electrons, the focusing therefore, can be attained in certain voltage ranges independently of the sign of the focus voltage.

The diameter of the gate opening and/or the diameter of the through-opening of the second insulating layer and/or the diameter of the through-opening of the focusing layer are, in particular, less than 100 μm, preferably less than 25 μm. In particular, the diameter gate opening can be less than 10 μm.

The focusing layer is made of an electrically conductive material. The electrical conductivity can be attained by doping the material of the focusing layer and/or be inherent in the material. For example, the electrically conductive material can be a metal. According to one advantageous embodiment, the focusing layer is made of tungsten in order to be more thermally resistant.

In the present application, the thickness of a layer refers, in particular, to the extent in the emission direction and/or along the longitudinal center axis of the emitter needle.

A thickness of the first insulating layer is, in particular, greater than a thickness of the gate electrode and/or a thickness of the second insulating layer and/or a thickness of the focusing layer. The thickness of the first insulating layer and/or the gate electrode and/or the second insulating layer and/or the focusing layer is typically constant.

A thickness of the first insulating layer is typically specified by a length of the emitter needle, which is frequently mechanically stabilized by the first insulating layer. The first insulating layer is typically so thick that it can insulate the voltage between the field-effect emission segment and the gate electrode. A thickness of this kind is important, in particular, if the first insulating layer abuts the inner wall of the gate opening.

A thickness of the gate electrode lies, in particular, between 0.01 μm and 25 μm, preferably between 0.1 μm and 2.5 μm, and/or is, for example, 0.24 μm. In particular, a thickness of the doped material can be 0.2 μm and the thickness of the top layer 0.04 μm.

A thickness of the second insulating layer lies, in particular, between 0.01 μm and 10 μm, preferably between 0.1 μm and 1 μm. The thickness of the second insulating layer has, in particular, a lower limit due to the dielectric strength of the second insulating layer, which depends, in particular, on the material and its thickness, and/or is dependent on the maximum focus voltage. The second insulating layer should preferably be at least so thick that the difference in potential between gate electrode and focusing layer is insulated.

A thickness of the focusing layer lies, in particular, between 0.1 μm and 100 μm, preferably between 1 μm and 15 μm. The focusing layer is advantageously as thick as possible in order to be thermally resistant to flashovers, provided that the free electrons can still pass at the same time. A thickness of the second insulating layer is preferably greater than a thickness of the gate electrode. A thickness of the focusing layer is preferably less than a thickness of the gate electrode.

A dimension of the emitter needle transverse to the longitudinal center axis is, for example, between 0.02 μm and 20 μm, in particular between 0.05 μm and 1 μm, advantageously 0.2 μm. The first end of the emitter needle can project into the gate opening, for example through to the center of the thickness of the gate electrode.

The diameter of the gate opening can be, for example, between 0.05 μm and 2 μm, in particular between 0.1 μm and 1 μm, advantageously 0.34 μm.

The gate opening and/or the through-opening of the second insulating layer and/or the through-opening of the focusing layer are in particular rotationally symmetric. A cross-section of the gate opening and/or the through-opening of the second insulating layer and/or the through-opening of the focusing layer can alternatively be embodied to be polygonal, in particular rectangular, preferably square.

The center axis of the gate opening and/or the through-opening of the second insulating layer and/or the through-opening of the focusing layer can coincide, in particular, with the longitudinal center axis of the emitter needle. In this case, the longitudinal center axis can centrally intersect, in particular, the gate opening and/or the through-opening of the second insulating layer and/or the through-opening of the focusing layer. It is alternatively conceivable that the longitudinal center axis has a spacing greater than zero and/or encloses an angle greater than zero in relation to the center axis of the gate opening and/or the through-opening of the second insulating layer and/or the through-opening of the focusing layer.

One embodiment provides that the diameter of the gate opening is smaller than the diameter of the through-opening of the focusing layer. This embodiment is advantageous, in particular, because the number of free electrons, which strike the focusing layer and are diverted from there via the focusing layer, can be reduced. The gate current is thus preferably reduced. In other words, a proportion of the free electrons, which can strike the anode, is advantageously increased.

One embodiment provides that the diameter of the gate opening is smaller than the diameter of the through-opening of the second insulating layer. This embodiment is advantageous, in particular, because charging of the second insulating layer with electrons, which strike the second insulating layer, can be reduced. A small or even no electrical field is thus produced in the second insulating layer, which could disrupt the trajectories of the free electrons.

One embodiment provides that the through-opening of the second insulating layer is embodied to widen in the emission direction of the emitter needle. In this case, in particular the diameter of the through-opening of the second insulating layer increases as the spacing from the gate electrode increases. This embodiment is advantageous, in particular, because the spatial distribution of the free electrons transverse to the emission direction increases in the immediate vicinity of the field-effect emission segment. The widening through-opening can advantageously compensate this effect and advantageously simultaneously optimally cover the gate electrode as well as reduce the entry of electrons into the second insulating layer.

One development of the previous embodiment provides that the through-opening of the second insulating layer is embodied with a frustoconical inner wall and that the inner wall of the through-opening of the second insulating layer encloses an angle greater than 0° and less than 60° in relation to the longitudinal center axis. This embodiment is advantageous, in particular, because the frustoconical inner wall is easy to manufacture and still makes said advantages possible. With this embodiment, the through-opening of the focusing layer and the gate opening are typically cylindrical. The center axes of the through-openings of the focusing layer as well as of the second insulating layer and of the gate opening coincide, in particular, with the longitudinal center axis of the emitter needle. The frustoconical inner wall of the second insulating layer is limited in the emission direction typically from the lower side of the focusing layer and/or counter to the emission direction, in particular from the upper side of the gate electrode.

One embodiment provides that the smallest diameter of the through-opening of the second insulating layer is larger than the largest diameter of the gate opening. This embodiment is advantageous, in particular, because the second insulating layer cannot interact with electrons which propagate parallel to the emission direction. This embodiment is particularly advantageous in combination with one of the previous two embodiments in which the through-opening of the second insulating layer is embodied to widen in the emission direction.

One embodiment provides that the transition of the upper side of the gate electrode to an inner wall of the gate opening is embodied to be arcuate. One advantage of this embodiment is the reduction achieved thereby in the electrical field strength at this transition. The transition is, in particular, the, for example, annular edge from the upper side to the inner wall. In other words, a corner between the inner wall of the gate opening and the upper side of the gate electrode is arcuate in cross-section parallel to the emission direction. Arcuate means that the gate electrode is processed in such a way that a radius of the transition is enlarged as planned. In other words, a pointedness of the transition is reduced by, for example, a rounding. Embodied to be arcuate means, in particular, manufactured to be arcuate and/or reworked to be arcuate.

One embodiment provides that the first insulating layer and the second insulating layer abut one another through the gate opening. In particular, the first insulating layer can abut the second insulating layer and/or the second insulating layer can abut the first insulating layer. The first insulating layer and the second insulating layer are preferably connected to one another without a gap, in particular through the gate opening. The first insulating layer and the second insulating layer are connected to one another in particular by way of a closed intermediate piece, which centrally has a through-opening for the emitter needle and/or the free electrons. The intermediate piece can be embodied to be annular, in particular. Without a gap means that at any height of the gate opening in the circumferential direction, is material of the first insulating layer or of the second insulating layer between the gate opening of the gate electrode. The intermediate piece, depending on point of view, the first insulating layer and/or the second insulating layer, preferably abuts the inner wall of the gate opening. In this case, the first insulating layer is advantageously made of the same material as the second insulating layer. This embodiment advantageously improves the insulating capacity of the first insulating layer and the second insulating layer. Advantageously, a gate current which discharges via the gate electrode is reduced in this embodiment.

One embodiment provides that the first end of the emitter needle has a projection greater than or equal to zero relative to the upper side of the gate electrode. The projection is, for example, between 0.001 μm and 1 μm, in particular between 0.01 μm and 0.4 μm. The projection of the first end refers, in particular, to the highest position of the emitter needle in the emission direction. Typically, the outermost end of the emitter needle has the highest position of the emitter needle relative to the emission direction, in particular therefore the termination of the tapered portion. With a projection equal to zero relative to the upper side, the first end of emitter needle is, in particular, flush with the upper side of the gate electrode. In this case, the first end of the emitter needle projects into the gate opening, but not beyond the gate opening. With a projection equal to zero, in particular no projection exists. With a projection equal to zero, in particular the upper side of the gate electrode relative to the first end of the emitter needle does not have a projection. With a projection equal to zero, the upper side of the gate electrode and the first end of the emitter needle are, in particular, equally high. With a projection greater than zero relative to the upper side, the first end of the emitter needle is arranged above the upper side of the gate electrode. In this case, the first end of the emitter needle projects into the gate opening and beyond the gate opening. Manufacture of the field-effect emitter microstructure is more challenging with this variant, in particular, owing to the positive projection. The inventors have identified that despite the projection, free electrons can be produced in the field-effect emission segment when the emission voltage is applied. This embodiment advantageously makes a reduction in the gate current, which discharges via the gate electrode, possible owing to the increased spacing of the free electrons from the gate electrode, whereby the free electrons are more likely to be sucked or accelerated away in the direction of the anode. This embodiment is particularly advantageous in combination with the previous embodiment. The intermediate piece can abut the sides of the field-effect emission segment, in particular, in this case.

One embodiment provides that the field-effect emitter microstructure has at least one further emitter needle and at least one further gate opening, wherein the longitudinal center axis of the at least one further emitter needle is aligned with the at least one further gate opening parallel to the emission direction of the emitter needle. Such a field-effect emitter microstructure forms, in particular, an array of field effect emitters. The number of emitter needles of the field-effect emitter microstructure can be greater than two, in particular greater than 100, preferably greater than 10,000 or 100,000, for example approx. 1,000,000. The emitter needle as well as the at least one further emitter needle preferably form an emission area to produce a current density of at least 1 A/cm\hat{ }2, advantageously at least 3 A/cm\hat{ }2, particularly advantageously at least 10 A/cm\hat{ }2.

Typically, one gate opening is associated with each emitter needle. The arrangement of the emitter needles relative to the respective gate opening is typically identical. The arrangement of a plurality of emitter needles can be distributed in a plane perpendicular to the emission direction. For example, the emitter needles can form a matrix with at least 2×2 per spatial direction. Typically, groups of emitter needles can be switched on and off jointly. It is conceivable that each emitter needle can be switched on and of independently of the other emitter needles. If specific regions of the field-effect emitter microstructure can be switched on and off, the field-effect emitter microstructure is, in particular, a segmented or pixelated emitter. The gate electrode can have the gate opening and the at least one further gate opening. In this case, the gate electrode is contiguous, i.e. not segmented. Alternatively, the gate electrode can have the gate opening and at least one further gate electrode can have the at least a further gate opening. In this case, an emission voltage and/or different emission voltages can advantageously be applied to the two gate electrodes independently of one another. It is conceivable to divide the first insulating layer and/or the second insulating layer and/or the focusing layer analogously to the gate electrode. It is advantageous for manufacture if, in particular, the first insulating layer and/or the second insulating layer is embodied to be contiguous. For applying different focus voltages it can be advantageous to embody the focusing layer so as to be segmented, i.e. not contiguous. Depending on the embodiment of the field-effect emitter microstructure, the gate electrode and/or the first insulating layer and/or the second insulating layer and/or the focusing layer can be embodied to be contiguous or segmented.

The computer program product can be a computer program or comprise a computer program. The computer program product has, in particular, the program code means which map the inventive method steps. As a result, the inventive method can be designed in a defined and repeatable manner as well as control exercised over dissemination of the inventive method. The computer program product is preferably configured in such a way that the computing unit can execute the inventive method steps via the computer program product. The program code means can, in particular, be loaded into a memory of the computing unit and can typically be executed via a processor of the computing unit with access to the memory. When the computer program product, in particular the program code means, is executed in the computing unit, typically all inventive embodiments of the described method can be carried out. The computer program product is saved, for example, on a physical, computer-readable medium and/or digitally stored as a data packet in a computer network. The computer program product can represent the physical, computer-readable medium and/or the data packet in the computer network. The invention can thus also start from the physical, computer-readable medium and/or the data packet in the computer network. The physical, computer-readable medium can customarily be directly connected to the computing unit, for example in that the physical, computer-readable medium is inserted in a DVD drive or pushed into a USB port, whereby the computing unit can access the physical, computer-readable medium, in particular by reading. The data packet can preferably be retrieved from the computer network. The computer network can have the computing unit or can be indirectly connected to the computing unit via a Wide Area Network (WAN) or a (Wireless) Local Area Network connection (WLAN or LAN). For example, the computer program product can be digitally stored on a Cloud server at a storage location of the computer network via the WAN via the Internet and/or can be transferred to the computing unit via the WLAN or LAN, in particular by the retrieval of a download link which refers to the storage location of the computer program product.

Features, advantages or alternative embodiments mentioned in the description of the apparatus are likewise to be transferred to the method, and vice versa. In other words, claims on the method can be developed with features of the apparatus, and vice versa. In particular, the inventive apparatus can be used in the method.

Independent of the grammatical term usage, individuals with male, female or other gender identities are included within the term.

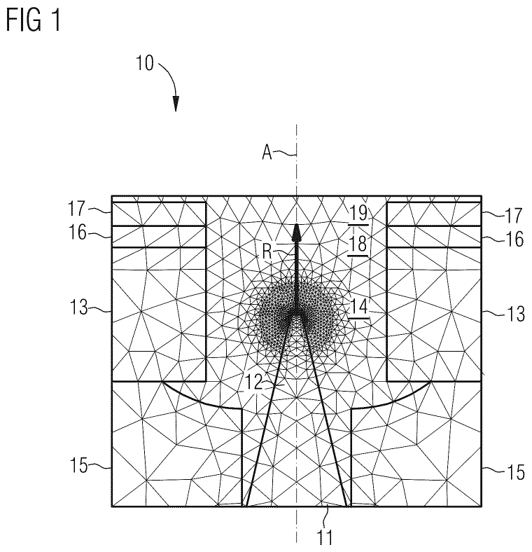

FIG. 1 shows an inventive field-effect emitter microstructure 10 in a longitudinal section along the emission direction R.

The field-effect emitter microstructure 10 has an emitter needle 11. The emitter needle 11 has a field-effect emission segment 12 at a first end.

The field-effect emitter microstructure 10 also has a gate electrode 13 with a gate opening 14. The gate opening 14 connects a lower side of the gate electrode 13 which faces the emitter needle 11 to an upper side of the gate electrode 13 which is remote from the lower side. The longitudinal center axis A of the emitter needle 11 perpendicular to the gate electrode 13 is aligned with the gate opening 14 in emission direction R.

The field-effect emitter microstructure 10 also has a first insulating layer 15. The first insulating layer 15 abuts the emitter needle 11, at least below the field-effect emission segment 12, not shown in FIG. 1, and at least partially abuts the lower side of the gate electrode 13. Free electrons can be produced in the field-effect emission segment 12 via an emission voltage which can be applied between the gate electrode 13 and the field-effect emission segment 12.

The field-effect emitter microstructure 10 also has a second insulating layer 16. The second insulating layer 16 has a lower side which faces the emitter needle 11 and an upper side which is remote from the lower side.

The field-effect emitter microstructure 10 also has an electrically conductive focusing layer 17. The electrically conductive focusing layer 17 has a lower side which faces the emitter needle 11 and an upper side which is remote from the lower side.

The lower side of the second insulating layer 16 at least partially abuts the upper side of the gate electrode 13. The upper side of the second insulating layer 16 at least partially abuts the lower side of the focusing layer 17. The second insulating layer 16 as well as the focusing layer 17 each have a through-opening 18, 19 for the free electrons which can be produced in the field-effect emission segment 12.

In FIG. 1 a diameter of the emitter needle 11 is smaller than a diameter of the gate opening 14 as well as a diameter of the through-openings 18, 19. The gate opening 14 as well as the through-openings 18, 19 are arranged centered around the longitudinal center axis A and have a constant diameter.

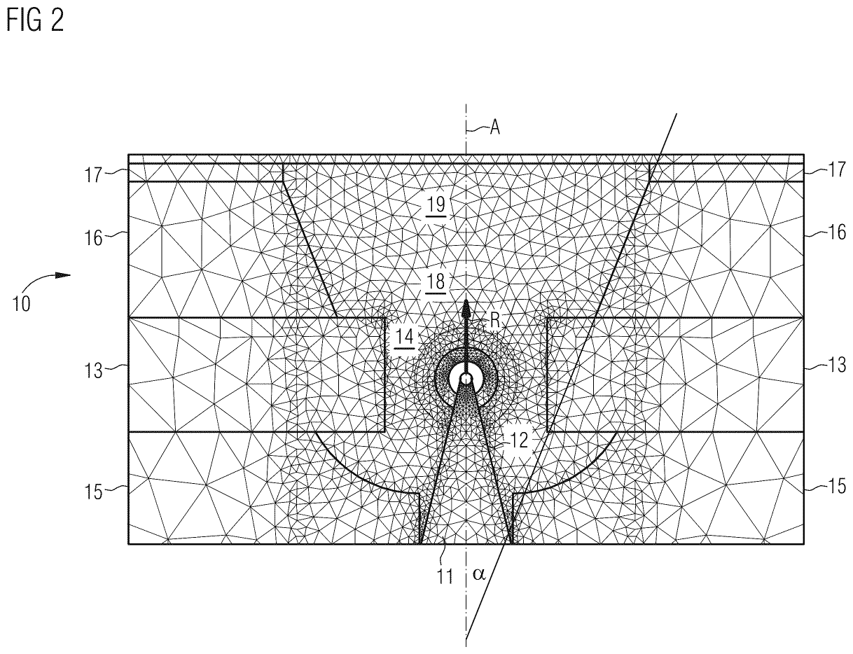

FIG. 2 shows a first exemplary embodiment of the field-effect emitter microstructure 10 in a longitudinal section along the emission direction R.

The diameter of the gate opening 14 is smaller than the diameter of the through-opening 19 of the focusing layer 17. The diameter of the gate opening 14 is smaller than the diameter of the through-opening 18 of the second insulating layer 16. The smallest diameter of the through-opening 18 of the second insulating layer 16 is larger than the largest diameter of the gate opening 14.

The through-opening 18 of the second insulating layer 16 is embodied to widen in the emission direction R of the emitter needle 11. The through-opening 18 of the second insulating layer 16 is embodied with a frustoconical inner wall. The inner wall of the through-opening 18 of the second insulating layer 16 encloses an angle α which is greater than 0° and less than 60° in relation to the longitudinal center axis A. The transition of the upper side of the gate electrode 13 to the inner wall of the gate opening 14 is embodied to be arcuate.

Advantageously, the second insulating layer 16 has a dielectric strength of at least 100 V/μm, preferably at least 400 V/μm. The focusing layer 18 can be made of tungsten.

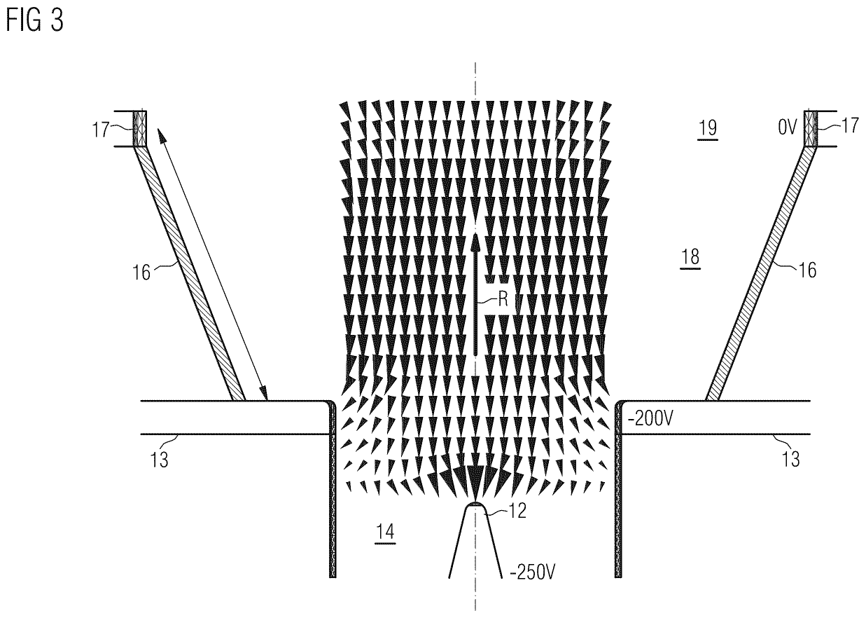

FIG. 3 shows a first operating behavior of the first exemplary embodiment.

FIG. 3 represents sections of the field components of the electrical field which result from a focus voltage of 200 V, starting from 0 V in the focusing layer, and an emission voltage of 50 V, starting from −200 V at the gate electrode. FIG. 3 represents the respective electrical potentials.

With a double arrow, FIG. 3 also represents the insulating distance. The insulating distance represents the distance that a focusing layer 17 which has been melted, for example by a flashover, has to span in order to be able to exert a disruptive effect on the gate electrode 13 and/or the emitter needle 11.

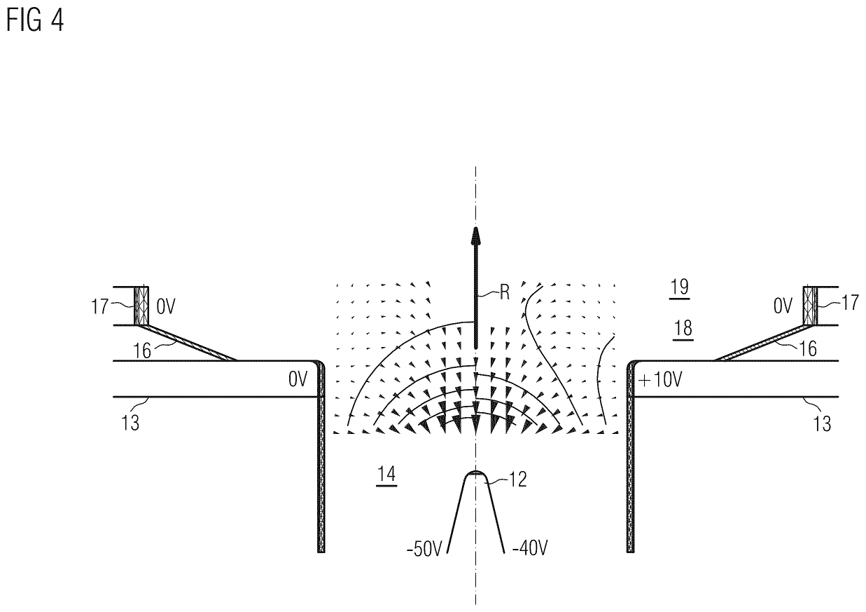

FIG. 4 shows a second (left) and a third (right) operating behavior of the first exemplary embodiment.

The left half of FIG. 4 represents sections of the field components of the electrical field which results from a focus voltage of 0 V, starting from 0 V in the focusing layer, and an emission voltage of 50 V, starting from 0 V at the gate electrode. The right half of FIG. 4 represents sections of the field components of the electrical field which results from a focus voltage of −10 V, starting from 0 V in the focusing layer, and an emission voltage of 50 V, starting from 10 V at the gate electrode. The respective electrical potentials are represented in FIG. 4.

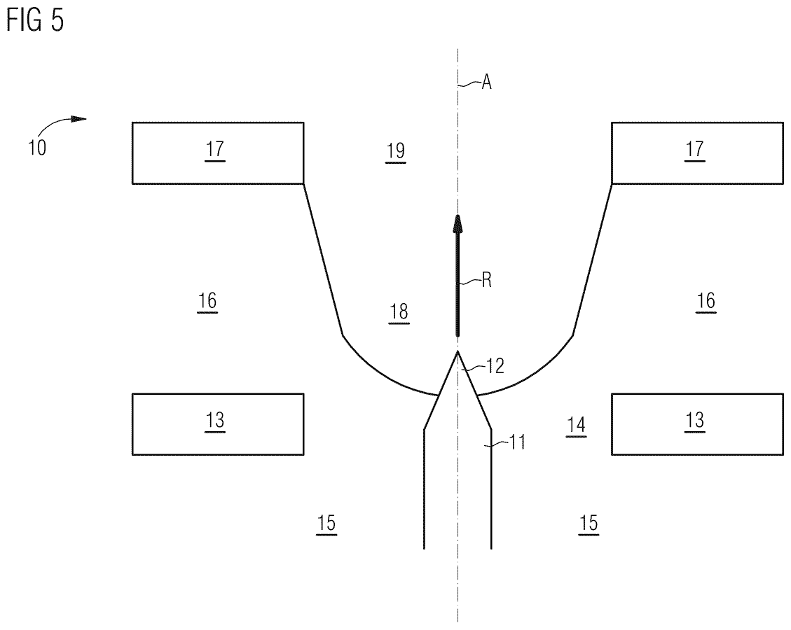

FIG. 5 shows a second exemplary embodiment of the field-effect emitter microstructure 10 in a longitudinal section along the emission direction R.

The first insulating layer 15 and the second insulating layer 16 adjoin one another through the gate opening 14. As represented in FIG. 5, the entire gate opening 14 can be completely filled by the first insulating layer 15 and/or the second insulating layer 16 as well as by the emitter needle 11. Alternatively, it is conceivable that the gate opening 14 is not completely filled by the first insulating layer 15 and/or the second insulating layer 16.

In FIG. 5 the first end of the emitter needle 11 has a projection greater than zero relative to the upper side of the gate electrode 13. In particular, the field-effect emission segment 12 has a projection greater than zero relative to the upper side of the gate electrode 13. In other words, the emitter needle 11 projects out of the gate opening 14 and/or through the gate opening 14. Alternatively, is es conceivable that the first end of the emitter needle 11 has a projection equal to zero relative to the upper side of the gate electrode, so the first end of the emitter needle 11 is flush with the upper side of the gate electrode.

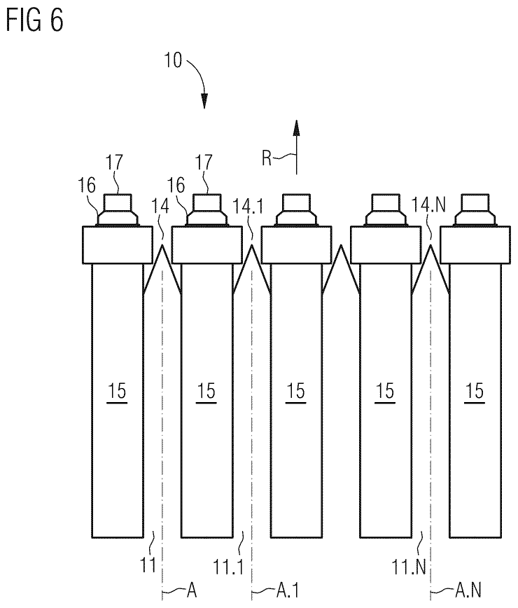

FIG. 6 shows a third exemplary embodiment of the field-effect emitter microstructure 10 in a longitudinal section along the emission direction R. The representation in FIG. 6 is not to scale.

The field-effect emitter microstructure 10 has at least one further emitter needle 11.1, . . . 11.N and at least one further gate opening 14.1, . . . 14.N. The longitudinal center axis A.1, . . . . A.N of the at least one further emitter needle 11.1, . . . 11.N is aligned with the at least one further gate opening 14.1, . . . 14.N parallel to the emission direction R of the emitter needle 11.

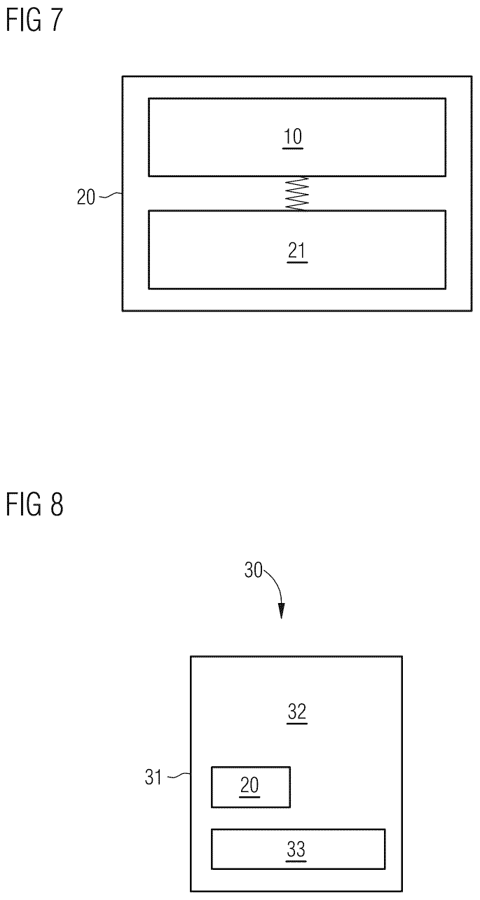

FIG. 7 shows an inventive electron emitter apparatus 20 in a block diagram.

The electron emitter apparatus 20 has a field-effect emitter microstructure 10 and a voltage source 21. The voltage source 21 is interconnected with the field effect microstructure 10 to provide an emission voltage and/or a focus voltage.

FIG. 8 shows an inventive X-ray tube 30 in a block diagram.

The X-ray tube 30 has a housing 31. The housing 31 has an evacuable interior 32.

The X-ray tube 30 also has an electron emitter apparatus 20. The electron emitter apparatus 20 is arranged in the interior 32.

The X-ray tube 30 also has an anode 33. The anode 33 is arranged in the interior 32 and is embodied to generate X-rays as a function of free electrons which can be generated via the electron emitter apparatus 20.

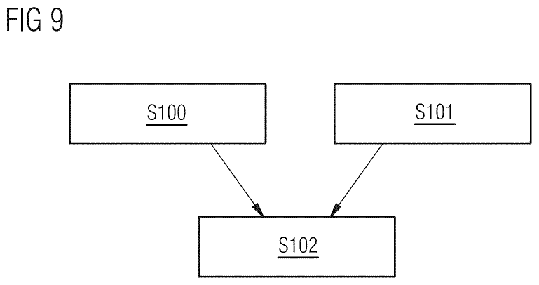

FIG. 9 shows in a flowchart an inventive method for generating X-rays via an X-ray tube.

Method step S100 marks application of an emission voltage between the gate electrode 13 and the emitter needle 11 to produce free electrons.

Method step S101 marks application of a focus voltage between the focusing layer 17 and the gate electrode 13 to focus the free electrons.

Method step S102 marks generation of X-rays via the anode 33 of the X-ray tube 30 by way of an interaction with the focused free electrons.

It is pointed out once again in conclusion that the method described in detail above, as well as the magnetic resonance apparatus shown, merely involve exemplary embodiments, which can be modified by the person skilled in the art in a very wide variety of ways without departing from the field of the invention. Furthermore the use of the indefinite article “a” or “an” does not exclude the features concerned also being able to be present a number of times. Likewise the terms “unit” and “element” do not exclude the components concerned consisting of a number of interacting part components, which where necessary can also be spatially distributed. Independent of the grammatical term usage of a specific person-related term, individuals with male, female or other gender identities should be included within the term.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements for features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (Soc), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

Although the invention has been illustrated and described in detail by the preferred exemplary embodiments, it is not restricted by the disclosed examples and a person skilled in the art can derive other variations herefrom without departing from the scope of the invention.

1. A field-effect emitter microstructure for an X-ray tube, the field-effect emitter microstructure comprising:
an emitter needle including a field-effect emission segment at a first end;
a gate electrode with a gate opening, the gate opening connecting a lower side of the gate electrode facing the emitter needle to an upper side of the gate electrode, a longitudinal center axis of the emitter needle perpendicular to the gate electrode is aligned with the gate opening in an emission direction;
a first insulating layer at least partially abutting the emitter needle at least below the field-effect emission segment and at least partially abutting the lower side of the gate electrode, wherein free electrons are producible in the field-effect emission segment via an emission voltage which can be applied between the gate electrode and the field-effect emission segment;
a second insulating layer having a lower side and an upper side, the lower side of the second insulating layer facing the emitter needle; and
an electrically conductive focusing layer with a lower side and an upper side, the lower side of the electrically conductive focusing layer facing the emitter needle,
wherein
the lower side of the second insulating layer at least partially abuts the upper side of the gate electrode,
the upper side of the second insulating layer at least partially abuts the lower side of the focusing layer, and
the second insulating layer and the focusing layer each have a through-opening for the free electrons.

2. The field-effect emitter microstructure of claim 1, wherein a diameter of the gate opening is smaller than a diameter of the through-opening of the focusing layer.

3. The field-effect emitter microstructure of claim 1, wherein a diameter of the gate opening is smaller than a diameter of the through-opening of the second insulating layer.

4. The field-effect emitter microstructure of claim 1, wherein the through-opening of the second insulating layer widens in the emission direction of the emitter needle.

5. The field-effect emitter microstructure of claim 4, wherein the through-opening of the second insulating layer includes a frustoconical inner wall and the frustoconical inner wall encloses an angle which is greater than 0° and less than 60° in relation to the longitudinal center axis.

6. The field-effect emitter microstructure of claim 1, wherein a smallest diameter of the through-opening of the second insulating layer is larger than a largest diameter of the gate opening.

7. The field-effect emitter microstructure of claim 1, wherein a transition of the upper side of the gate electrode to an inner wall of the gate opening is arcuate.

8. The field-effect emitter microstructure of claim 1, wherein the second insulating layer has a dielectric strength of at least 100 V/μm.

9. The field-effect emitter microstructure of claim 1, wherein the focusing layer is made of tungsten.

10. The field-effect emitter microstructure of claim 1, wherein the first insulating layer and the second insulating layer abut one another through the gate opening.

11. The field-effect emitter microstructure of claim 1, wherein the first end of the emitter needle has a projection greater than or equal to zero relative to the upper side of the gate electrode.

12. The field-effect emitter microstructure of claim 1, wherein the field-effect emitter microstructure has at least one further emitter needle and at least one further gate opening, wherein a longitudinal center axis of the at least one further emitter needle is aligned with the at least one further gate opening parallel to the emission direction of the emitter needle.

13. An electron emitter apparatus, comprising:
the field-effect emitter microstructure of claim 1; and
a voltage source interconnected with the field-effect emitter microstructure to provide at least one of an emission voltage or a focus voltage.

14. An X-ray tube, comprising:
a housing with a evacuable interior;
the electron emitter apparatus of claim 13 in the evacuable interior; and
an anode in the evacuable interior, the anode configured to generate X-rays as a function of the free electrons.

15. A method for generating X-rays via the X-ray tube of claim 14, the method comprising:
applying an emission voltage between the gate electrode and the emitter needle for producing free electrons;
applying a focus voltage between the focusing layer and the gate electrode for focusing the free electrons; and
generating X-rays via the anode of the X-ray tube by way of an interaction with the focused free electrons.

16. The field-effect emitter microstructure of claim 8, wherein the dielectric strength of the second insulating layer is at least 400 V/μm.

17. The field-effect emitter microstructure of claim 5, wherein a smallest diameter of the through-opening of the second insulating layer is larger than a largest diameter of the gate opening.

18. The field-effect emitter microstructure of claim 17, wherein a transition of the upper side of the gate electrode to an inner wall of the gate opening is arcuate.

19. The field-effect emitter microstructure of claim 7, wherein the second insulating layer has a dielectric strength of at least 100 V/μm.

20. The field-effect emitter microstructure of claim 19, wherein the field-effect emitter microstructure has at least one further emitter needle and at least one further gate opening, wherein a longitudinal center axis of the at least one further emitter needle is aligned with the at least one further gate opening parallel to the emission direction of the emitter needle.
